(19) United States
(12) Patent Application Publication
(10) Pub. No.: US 2023/0401367 A1
(43) Pub. Date: Dec. 14, 2023

(54) DRL-BASED CONTROL LOGIC DESIGN METHOD FOR CONTINUOUS MICROFLUIDIC BIOCHIPS

(71) Applicant: FUZHOU UNIVERSITY, Fuzhou (CN)

(72) Inventors: Wenzhong GUO, Fuzhou (CN); Huayang CAI, Fuzhou (CN); Genggeng LIU, Fuzhou (CN); Xing HUANG, Fuzhou (CN); Guolong CHEN, Fuzhou (CN)

(73) Assignee: FUZHOU UNIVERSITY, Fuzhou (CN)

(21) Appl. No.: 18/238,562

(22) Filed: Aug. 28, 2023

Related U.S. Application Data
(63) Continuation of application No. PCT/CN2023/089652, filed on Apr. 21, 2023.

(30) Foreign Application Priority Data
May 27, 2022 (CN) 202210585659.2

(51) Int. Cl. G06F 30/337; G06F 17/11

(52) U.S. Cl. CPC G06F 30/337; G06F 17/11; G06F 2115/02

(57) ABSTRACT

A DRL-based control logic design method for continuous microfluidic biochips is provided. Firstly, an integer linear programming model is for effectively solving multi-channel switching calculation to minimize the number of time slices required by the control logic. Secondly, a control logic synthesis method based on deep reinforcement learning, which uses a double deep Q network and two Boolean logic simplification techniques to find a more effective pattern allocation scheme for the control logic.

### CROSS REFERENCE TO THE RELATED APPLICATIONS

This application is a continuation application of International Application No. PCT/CN2023/089652, filed on Apr. 21, 2023, which is based upon and claims priority to Chinese Patent Application No. 202210585659.2, filed on May 27, 2022, the entire contents of which are incorporated herein by reference.

### TECHNICAL FIELD

The present invention belongs to the technical field of computer-aided design of continuous microfluidic biochips, in particular relates to a DRL-based control logic design method for continuous microfluidic biochips.

### BACKGROUND

Continuous microfluidic biochips, also known as laboratory equipments on a chip, have received a lot of attentions in the last decade due to their advantages of high efficiency, high precision and low cost. With the development of such chips, traditional biological and biochemical experiments have been fundamentally changed. Compared with traditional experimental procedures that require manual operations, the execution efficiency and reliability of bioassay are greatly improved because the biochemical operations in biochips are automatically controlled by internal microcontrollers. In addition, this automated process avoids a false detection result due to human intervention. As a result, such laboratory equipments on such chip are increasingly used in some areas of biochemistry and biomedicine, such as drug discovery and cancer detection.

With advances in manufacturing technology, thousands of valves are now capable of being integrated into a single chip. These valves are arranged in a compact, regular arrangement to form a flexible, reconfigurable and universal platform, which is a Fully Programmable Valve Array (FPVA) and is capable of being used to control the execution of bioassay. However, because FPVA itself contains a large number of micro-valves, it is impractical to assign a separate pressure source to each valve. To reduce the number of pressure sources, a control logic with multiplexing capabilities is used to control valve status in the FPVA. To sum up, the control logic plays a crucial role in the biochips.

In recent years, several methods have been proposed to optimize the control logic in the biochips. For example, control logic synthesis is investigated to reduce the number of control ports used in the biochips; the relationship between switching patterns is investigated in the control logic, and the switching time of the valve is optimized by adjusting a pattern sequence required by a control valve; and, the structure of the control logic is investigated, so that a multi-channel switching mechanism is introduced to reduce the switching time of the control valve. At the same time, an independent backup path is also introduced to realize fault tolerance of the control logic. However, none of the above methods take sufficient account of the allocation order between a control pattern and a multi-channel combination, resulting in the use of redundant resources in the control logic.

Based on the above analysis, we propose PatternActor, a deep reinforcement learning based control logic design method for continuous microfluidic biochips. By using the proposed method, the number of time slices and control valves used in the control logic is capable of being greatly reduced, and better control logic synthesis performance is brought, so as to further reduce a total cost of the control logic and improve the execution efficiency of biochemical applications. According to our investigation, the present invention is the first time to carry out research by using the method of deep reinforcement learning to optimize the control logic.

### SUMMARY

The purpose of the present invention is to provide a Deep Reinforcement Learning (DRL) based control logic design method for continuous microfluidic biochips. By using the proposed method, the number of time slices and control valves used in the control logic is capable of being greatly reduced, and better control logic synthesis performance is brought, so as to further reduce a total cost of the control logic and improve the execution efficiency of biochemical applications.

To realize the above purpose, the technical solution of the present invention is as follows: a DRL-based control logic design method for continuous microfluidic biochips, wherein the method comprises the following steps:
S1. calculating a multi-channel switching scheme: constructing an integer linear programming model to minimize the number of time slices required by a control logic, thereby obtaining the multi-channel switching scheme;
S2. allocating control patterns: after obtaining the multi-channel switching scheme, allocating a corresponding control pattern for each multi-channel combination in the multi-channel switching scheme; and
S3. performing a PatternActor optimization: constructing a control logic synthesis method based on deep reinforcement learning, and optimizing a generated control pattern allocation scheme to minimize the number of control valves used.

Compared with the prior art, the present invention has the following beneficial effects: by using the proposed method, the number of time slices and control valves used in the control logic is capable of being greatly reduced, and better control logic synthesis performance is brought, so as to further reduce a total cost of the control logic and improve the execution efficiency of the biochemical applications.

### BRIEF DESCRIPTION OF THE DRAWINGS

FIG. 1 is an overall flow chart of a control logic design;

FIG. 2 is a control logic diagram of a multiplexed three-channel;

FIG. 3A shows a control pattern used to update the status of control channel 1 and control channel 3 at the same time;

FIG. 3B shows a control logic after logical simplification of FIG. 3A;

FIG. 4 shows a relation diagram of a switching matrix and a corresponding joint vector group and a method array;

FIG. 5 shows a flow chart of interaction between an agent and environment;

FIG. 6 shows simplification of an internal logic tree of flow valves f₂;

FIG. 7 shows a logical tree of flow valves f₁, f₂ and f₃ to construct a logical forest; and

FIG. 8 shows a double deep Q-network (DDQN) parameter update process.

### DETAILED DESCRIPTION OF THE EMBODIMENTS

The technical solution of the present invention is described in detail in combination with the accompany drawings.

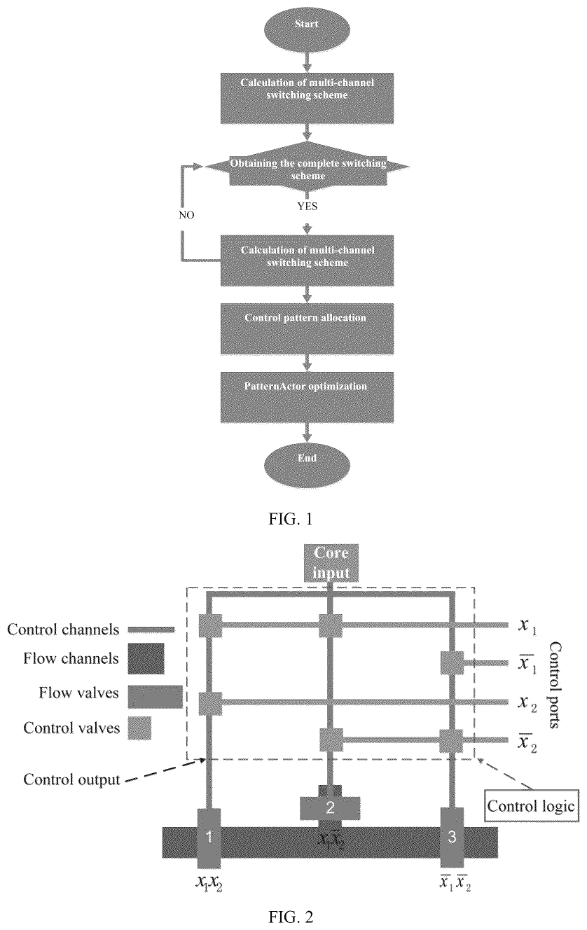

Proposed in the present invention is a DRL-based control logic design method for continuous microfluidic biochips. Overall steps are as shown in FIG. 1.

The method specifically comprises the following design process:
1. Input data of the process is a state transition sequence of all flow valves/control channels in a given biochemical application, and output data is an optimized control logic supporting a multi-channel switching function. The process consists of two sub-processes, one is a multi-channel switching scheme calculation process and the other is a control logic synthesis process. The control logic synthesis process comprises a control pattern allocation process and an optimization process for PatternActor.
2. In the multi-channel switching scheme calculation process, a new integer linear programming model is constructed to reduce the number of time slices used by a control logic as many as possible and optimize a calculation process of time slice minimization. The optimization of the switching scheme greatly improves the efficiency of searching available multi-channel combinations in the control logic and the reliability of valve switching in the control logic with large scale of channels.
3. After obtaining the multi-channel switching scheme, the control logic synthesis process firstly allocates corresponding control patterns for each multi-channel combination, that is, the control pattern allocation process.
4. The optimization process of PatternActor is to construct the control logic based on deep reinforcement learning. It mainly uses a double deep Q network and two Boolean logic simplification techniques to find a more effective pattern allocation scheme for the control logic. The process optimizes the control pattern distribution scheme generated by the process to minimize the number of control valves used as many as possible.

The specific technical solution of the present invention is realized as follows:
1. Multi-channel switching technology:

Normally, the transition of a control channel from a state in time t to a state in time t+1 is called a time interval. In this time interval, the control logic may need to make a plurality of times of changes to the state of the control channel, so a time interval may consist of one or more time slices, each of which involves changing the state of a relevant control channel. For an original control logic with a multiplexing function, each time slice only involves switching the state of one control channel.

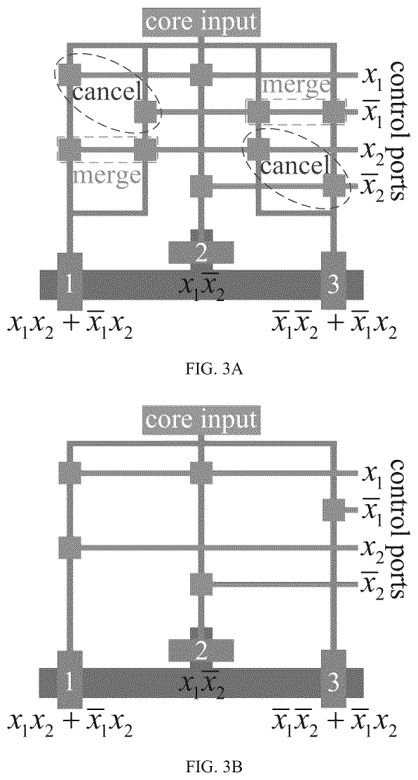

As shown in FIG. 2, based on the control logic with a channel multiplexing function, the current control logic needs to change the states of the three control channels. Assuming that the state transition sequences of the control channels is 101 to 010, it can be found that the state of a first control channel and the state of a third control channel are both from 1 to 0, so the state switching operations of the two channels are capable of being merged. Note in FIG. 1 that only three control patterns are used at this time, with one remaining control pattern x̅₁x₂ unused. In this case, the control pattern x̅₁x₂ is capable of being used to control the state of control channel 1 and state of control channel 3 at the same time, as shown in FIG. 3A. We can call this mechanism as multi-channel switching, by which we can effectively reduce the number of time slices required in the process of state switching. For example, in this example, when the state transition sequence is from 101 to 010, the number of time slices required by the control logic with the multi-channel switching is reduced from 3 to 2 compared to the original control logic.

In FIG. 3A, we assign two control channels each for a flow valve 1 and a flow valve 3 to drive changes in their states. Note that there are two control valves at the top of the two control channels for driving flow valve 3, and they are both connected to a control port x̅₁. Therefore, for these two control valves, we can adopt a merge operation, that is, merging two identical control valves into one to control the inputs at the top of both channels at the same time. Similarly, the control valves at the bottom of the two channels are complementary, so we can use a subtracting operation to eliminate the use of both valves herein. The reason is that at least one of the two control channels used to drive the flow valve 3 is capable of transmitting a core input signal, regardless of whether the bottom of the channel activates x₂ or x̅₂, if the x̅₁ control valve at the top is in an open state. Similarly, the merging and cutting operations on the control valves also apply to the two control channels for driving the flow valve 1. The simplified control logic structure of the above valves is shown in FIG. 3B. At this time, the control channel 1 and the control channel 3 actually need only one control valve respectively to drive the corresponding flow valve so as to change their states. The merging and cutting operations in the logical structure are essentially based on the simplification method of Boolean logic, which is reflected in this example as the formulas: x₁x₂+x̅₁ x₂=x₂ and x̅₁x̅₂+x̅₁ x₂=x̅₁. It not only realizes the simplification of internal resources of the control logic, but also guarantees a function of multi-channel switching. Compared to FIG. 3A, the number of control valves used by the control logic in FIG. 3B is reduced from 10 to 4.
2. A Calculation Flow of the Multi-Channel Switching Scheme

In order to realize the multi-channel switching of the control logic and reduce the number of time slices in the process of state switching, the most important thing is to obtain which control channels need to switch states simultaneously. Herein we consider the case where the biochemical application state transitions have been given, the control channel states known at each moment are used to reduce the number of time slices in the control logic. A state matrix \tilde{P} is constructed to contain a whole state transition process of the application, wherein each row in the \tilde{P} matrix represents a state of each control channel at every moment. For example, for the state transition sequence: 101→010→100→011, the state matrix \tilde{P} can be written as:

$$\tilde{P} = ( \begin{matrix}1 & 0 & 1 \\ 0 & 1 & 0 \\ 1 & 0 & 0 \\ 0 & 1 & 1\end{matrix} ) \qquad ( 1 )$$

In the above given state transition sequence, for the state transition from 101→010, the first control channel and third control channel need to be connected to a core input firstly, and the pressure value of the core input is set to be 0, and then transmitted to the corresponding flow valve through these two channels. Secondly, the second control channel is connected to the core input. At this time, the pressure value of the core input needs to be set to 1, which is also transmitted to the corresponding flow valve through this channel. In addition, the switching matrix \tilde{Y} is used to represent the above two operations needed to be performed in the control logic. In the switching matrix \tilde{Y}, element 1 represents that a control channel is now connected to the core input and that the status value in the current channel has been updated to the same pressure value as the core input. Element 0 represents that a control channel is now not connected to the core input and that the status value in the current channel is not updated. Therefore, according to the state matrix in the example, the corresponding switching matrix \tilde{Y}can be obtained as:

$$\tilde{Y} = ( \begin{matrix}1 & 0 & 1 \\ 0 & 1 & 0 \\ 1 & 0 & 0 \\ 0 & 1 & X \\ 1 & 0 & 0 \\ 0 & 1 & 1\end{matrix} ) \qquad ( 2 )$$

Each row of the \tilde{Y} matrix is called a switching pattern. It is noted that there is an element with value X in the matrix \tilde{Y}, because in some state transition processes, such as the state transition from 010→100, the state value of the third control channel is unchanged at two adjacent moments. Therefore, the third control channel can choose to update the state value at the same time as the first control channel, and can also choose not to do any operation to keep its own state value unchanged. For a switching pattern in which each row of the \tilde{Y} matrix has more than one 1 elements, the states of a plurality of control channels corresponding to the switching pattern may not be updated at the same time. At this time, it is necessary to divide the switching pattern into a plurality of time slices and use a plurality of corresponding multi-channel combinations to complete the switching pattern. Therefore, in order to reduce the total number of time slices required by the overall state switching, the multi-channel combination corresponding to each switching pattern should be carefully selected. For the switching matrix \tilde{Y}, the number of rows in the matrix is the total number of switching patterns required to complete all state transitions, and the number of columns is the total number of control channels in the control logic.

In this example, a goal at moment is to select efficient multi-channel combinations to implement all switching patterns in the switching matrix \tilde{Y}while ensuring that the total number of time slices used to complete the process is minimal.

For N control channels, 2^{N}−1 multi-channel combinations can be represented by a multiplexed matrix \tilde{X} with N columns, where one or more combinations need to be selected from all the rows in the \tilde{X} matrix to achieve the switching pattern represented by each row in the \tilde{Y} matrix. In fact, for the switching pattern of each row in the switching matrix \tilde{Y}, the number of feasible multi-channel combinations that can realize the switching pattern is far less than the total number of multi-channel combinations in the multiplexing matrix \tilde{X}. A closer look reveals that the multi-channel combinations that enable the switching pattern is determined by the position and number of element 1 in the pattern. For example, for the switching pattern 011, the number of elements 1 is 2 and their positions are respectively in the second and third positions of the whole switching pattern, which means that the multi-channel combinations to realize the switching pattern are only related to the second channel and third control channel in the control logic. Therefore, the optional multi-channel combinations that can realize the switching pattern 011 are respectively 011,010 and 001, and only three multi-channel combinations are needed herein. Using this feature, we can infer that the number of optional multi-channel combinations to realize a certain switching pattern is 2ⁿ−1, wherein n represents the number of elements 1 in the switching pattern.

As described above, for the switching pattern for each row in the switching matrix, a joint vector group \vec{M} can be constructed to contain alternative multi-channel combinations that can make up each switching pattern. For example, for the switching matrix \tilde{Y} in the above example, the corresponding joint vector group \vec{M} is defined as:

$$\vec{M} = ( \begin{matrix}( \begin{matrix}1 & 0 & 1 \\ 1 & 0 & 0 \\ 0 & 0 & 1\end{matrix} ) \\ ( 010 ) \\ ( 100 ) \\ ( 010 ) \\ ( 100 ) \\ ( \begin{matrix}0 & 0 & 1 \\ 0 & 1 & 0 \\ 0 & 1 & 1\end{matrix} )\end{matrix} ) \qquad ( 3 )$$

The number of vector groups in the joint vector group \vec{M} is the same as the number of rows X in the switching matrix, and each vector group contains 2ⁿ−1 sub-vectors with dimension N, which are optional multi-channel combinations to achieve the corresponding switching pattern. When the element m_{i,j,k} in the joint vector group \vec{M} is 1, it means that the control channel corresponding to the element is related to the realization of the i-th switching pattern.

Since an ultimate goal of the multi-channel switching scheme is to realize a switching matrix \tilde{Y} by selecting multi-channel combinations represented by the sub-vectors of each vector group in the joint vector group \vec{M}, a method array \hat{T} is constructed to represent the positions in \vec{M} of the corresponding multi-channel combinations used for the switching pattern of each row in the switching matrix \tilde{Y}. At the same time, it is also convenient to obtain a specific multi-channel combination required. The method array \hat{T} contains X sub-arrays (consistent with the number of rows in the switching matrix \tilde{Y}), and the number of elements in the sub-array is determined by the number of elements 1 in the switching pattern corresponding to the sub-array, that is, the number of elements in the sub-array is 2ⁿ−1. For the above example, the method array \hat{T} ′ is defined as follows:

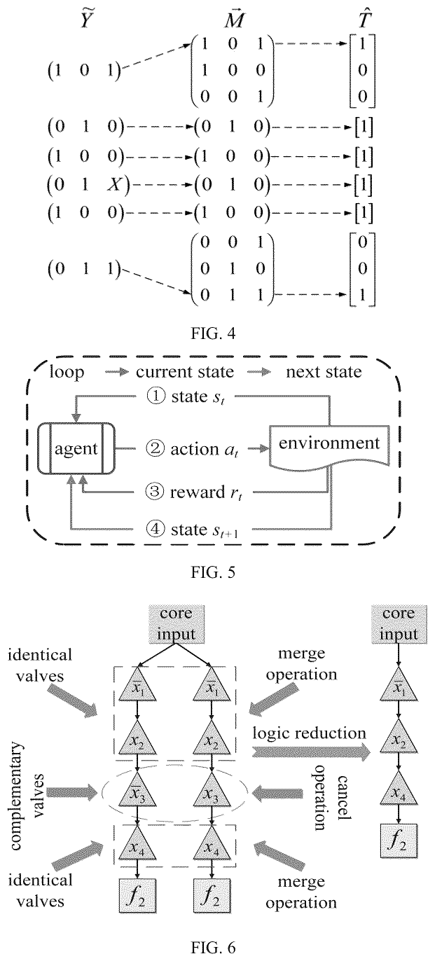

T=[[0,0,1],[1],[1],[1],[1],[0,0,1]] (4)

wherein, the i-th sub-array in \hat{T} represents that some combinations of the i-th vector group in \vec{M} are selected to realize the switching pattern of the i-th row of the switching matrix. For example, FIG. 4 shows a relationship between a switching matrix \tilde{Y} in (2) and its corresponding joint vector group \vec{M} and method array \hat{T}. It can be noted that there are 6 vector groups in total in \vec{M}. The switching pattern of corresponding rows in the matrix f is realized by respectively selecting the sub-vectors in the 6 vector groups. The sub-vectors between different vector groups are allowed to repeat, and finally only 4 different multi-channel combinations are needed to complete all the switching patterns in the switching matrix \tilde{Y}. For example, for the switching pattern 101 of the first row in \tilde{Y}, the multi-channel combination 101 represented by a first sub-vector in the first vector group in \vec{M} is selected. Herein, only a time slice is needed to update the states of the first and third control channels.

For element y_{i,k} in the matrix \tilde{Y}, when the value of the element is 1, it indicates that an i-th switching pattern involves a k-th control channel to realize the state switching, so it is necessary to select a sub-vector that is also 1 in the k-th column from the i-th vector group in the vector \vec{M} to realize the switching pattern. This constraint may be expressed as follows:

$${\sum }_{j = 0}^{j = H ( j ) - 1} {t}_{i , j} {m}_{i , j , k} \{ \begin{matrix}\geq 1 , {y}_{i , k} = 1 \\ = 0 , {y}_{i , k} = 0\end{matrix} \\ ∀ i = 0 , … , X - 1 , k = 0 , … , N - 1 \qquad ( 5 )$$

wherein H(j) represents the number of sub-vectors in a j-th vector group in the joint vector group \vec{M}. m_{i,j,k} and y_{i,k} are given constants, and t_{i,j} is a binary variable with value of 0 or 1, and its value is ultimately determined by a solver.

The maximum number of control patterns allowed to be used in the control logic is usually determined by the number of external pressure sources, and is expressed as a constant Q_{cw} with a value of 2┌log₂N┐, which is usually much less than 2^{N}-1. In addition, for the sub-vectors selected from the joint vector group \vec{M}, a binary row vector \vec{G} with a value of 0 or 1 is constructed to record the non-repeating sub-vectors finally selected (multi-channel combinations). The total number of non-repeating sub-vectors finally selected cannot be greater than Q_{cw}, so the constraint is as follows:

$${\sum }_{i = 0}^{i = c - 1} {G}_{i} \leq {Q}_{cw} \qquad ( 6 )$$

wherein c represents the total number of non-repeating sub-vectors contained in the joint vector group \vec{M}.

If the j-th element of the i-th sub-array in the method array \hat{T} is not 1, then the multi-channel combination represented by the j-th sub-vector of the i-th vector group in the joint vector group \vec{M} is not selected. However, other sub-vectors with the same value of elements as the sub-vector may exist in other vector groups in the joint vector group \vec{M}, so a multi-channel combination with the same values of the elements may still be selected. Only when a certain multi-channel combination is not selected in the whole process, the column element corresponding to the multi-channel combination in G is set to be 0, and its constraint is:

t_{i,j}≤G_{[m}_{_{I,j}}_{]} (7)

∀i=0, . . . ,X−1,j=0, . . . ,H(j)
wherein [m_{i,j}] represents the position in \vec{G} of multi-channel combination with the same values of elements as the j-th sub-vector of the i-th vector group in \vec{M}.

Each sub-array in \hat{T} indicates which multi-channel combinations represented by sub-vectors are selected from the vector group of \vec{M} to implement the corresponding switching pattern in \tilde{Y}. The number of elements 1 in each sub-array in \hat{T} represents the number of time slices required to implement the corresponding switching pattern in \tilde{Y} in the sub-array. Therefore, in order to minimize the total number of time slices for realizing all switching patterns in \tilde{Y}, the optimization problem that can be solved are as follows:

$$minimize {\sum }_{i = 0}^{X - I} {\sum }_{j = 0}^{H ( j ) - 1} {t}_{i , j} \\ s . t . ( 5 ) , ( 6 ) , ( 7 ) . \qquad ( 8 )$$

By solving the optimization problem as shown above, the multi-channel combinations required to realize the whole switching scheme is obtained according to the value of \vec{G}. Also, the multi-channel combination used for switching pattern for each row in \tilde{Y} is determined by the value of t_{i,j}. That is, when the value of t_{i,j} is 1, the multi-channel combination is the value of the sub-vector represented by M_{t,j}.

3. An allocation process of control pattern:

By solving the integer linear programming model constructed as above, independent or simultaneous switching control channels can be obtained. These channels are collectively referred to as the multi-channel switching scheme. The scheme is represented by a multi-path matrix, as shown in (9). In this matrix, there are nine flow valves (i.e. f₁_f₉) connected to the core input, and there are five multi-channel combinations in total to achieve the multi-channel switching. In this case, each of these five combinations needs to be allocated a control pattern. Herein, we firstly assign five different control patterns to the multi-channel combinations in each row of the matrix. These control patterns are located on the right side of the matrix. This allocation process is the basis of building a complete control logic.

$$( \begin{matrix}1 & 0 & 0 & 0 & 1 & 0 & 1 & 0 & 0 \\ 1 & 1 & 0 & 0 & 0 & 0 & 0 & 0 & 0 \\ 0 & 0 & 1 & 0 & 0 & 1 & 0 & 1 & 0 \\ 0 & 1 & 1 & 0 & 0 & 0 & 0 & 0 & 0 \\ 1 & 0 & 1 & 0 & 0 & 1 & 0 & 0 & 0\end{matrix} ) \begin{matrix}{\overline{x}}_{1} {\overline{x}}_{2} {x}_{3} {x}_{4} \\ {\overline{x}}_{1} {x}_{2} {\overline{x}}_{3} {x}_{4} \\ {\overline{x}}_{1} {x}_{2} {x}_{3} {\overline{x}}_{4} \\ {\overline{x}}_{1} {x}_{2} {x}_{3} {x}_{4} \\ {x}_{1} {x}_{2} {x}_{3} {x}_{4}\end{matrix} \qquad ( 9 )$$

4. An optimization process for PatternActor:

For control channels that require the state switching, the appropriate control pattern must be carefully selected. In the present invention, we propose a method PatternActor based on the deep reinforcement learning to seek a more effective pattern allocation scheme for control logic synthesis. Specifically, it focuses on building DDQN models as reinforcement learning agents, which can use effective pattern information to learn how to allocate control patterns, so as to obtain which pattern is more effective for a given multi-channel combination.

The basic idea of deep reinforcement learning is that agents constantly adjust their decisions made at each time t to obtain the overall optimal policy. This policy adjustment is based on the reward returned by the interaction between the agent and the environment. The flow chart of interaction is as shown in FIG. 5. This process is mainly related to three elements: an agent state, a reward from environment and an action taken by the agent. Firstly, the agent perceives the current state sₜ at time t and selects an action aₜ from an action space. Next, the agent receives a reward rₜ from the environment when it takes an aₜ action. The current state is then moved to a next state sₜ₊₁, and the agent selects a new action for this new state sₜ₊₁. Finally, through an iterative updating process, an optimal policy P_{best} is found, which maximizes the long-term cumulative reward of the agent.

For the optimization process for PatternActor, the present invention mainly uses deep neural networks (DNNs) to record data, while it can effectively approximate a state value function used to find the optimal policy. In addition to determining the model for recording data, the above three elements need to be designed next to build a deep reinforcement learning framework for the control logic synthesis.

Before designing the three elements, we firstly initialize the number of control ports available in the control logic as 2×┌log₂N┐, and these ports can form 2┌log₂N┐ control patterns accordingly. In the present invention, the main objective of the process is to select an appropriate control pattern for the multi-channel combination, thus ensuring that the total cost of the control logic is minimized.

4.1. State Design of PatternActor

Before selecting the appropriate control pattern for the multi-channel combination, it firstly needs to design the agent state. The state represents the current situation, which affects the selection of control pattern of the agent. It is usually expressed as s. We design the state by concatenating a multi-channel combination of time t with a coded sequence of selected actions at all time. The purpose of this state design is to ensure that the agent can take into account the current multi-channel combination and the existing pattern allocation scheme, so that the agent can make better decisions. Note that the length of the encoding sequence is equal to the number of rows in the multi-path matrix, that is, each multi-channel combination corresponds to one bit of action code.

Take the multi-path matrix in (10) as an example, the initial state s₀ is designed according to the combination represented by the first row of the multi-path matrix, and the time t increases with the number of rows of the matrix. Therefore, the current state at t+2 should be represented as sₜ₊₂. Accordingly, the multi-channel combination “001001010” in the third row of the multi-path matrix needs to be assigned a control pattern. If the two combinations of the first two rows of the multi-path matrix are allocated to the second and third control patterns, respectively, then the state sₜ₊₂ is designed to be (00100101023000). Since the combinations under the current and subsequent moments are not allocated to any control pattern, the action codes corresponding to these combinations are represented by zeros in the sequence. All the states herein form a state space S.

$$( \begin{matrix}1 & 0 & 0 & 0 & 1 & 0 & 1 & 0 & 0 \\ 1 & 1 & 0 & 0 & 0 & 0 & 0 & 0 & 0 \\ 0 & 0 & 1 & 0 & 0 & 1 & 0 & 1 & 0 \\ 0 & 1 & 1 & 0 & 0 & 0 & 0 & 0 & 0 \\ 1 & 0 & 1 & 0 & 0 & 1 & 0 & 0 & 0\end{matrix} ) \begin{matrix}{\overline{x}}_{1} {x}_{2} {\overline{x}}_{3} {x}_{4} \\ \\ {\overline{x}}_{1} {x}_{2} {x}_{3} {x}_{4}\end{matrix} \qquad ( 10 )$$

4.2. Action Design of PatternActor

An action represents what the agent decides to do in the current state and is usually represented as a. Since the multi-channel combination needs to allocate the corresponding control pattern, the action is naturally the unselected control pattern. Each control pattern can be selected only once, and all control patterns generated by the control port constitute an action space A. In addition, the control patterns in A are encoded in an ascending order of serial number “1”, “2”, “3”, etc. When the agent takes an action in a certain state, the action code indicates which control pattern has been allocated.

4.3. Reward Function Design of PatternActor

The reward represents a revenue that the agent gets by taking an action, usually expressed as r. By designing the reward function of the state, the agent can obtain effective signals and learn in a right way. For a multi-path matrix, assuming that the number of rows in the matrix is h, we represent an initial state as sᵢ and a termination state as sᵢ₊ₕ₋₁ accordingly. In order to guide agents to obtain a more efficient pattern allocation scheme, the design of reward function needs to involve two Boolean logic simplification methods: a logic tree simplification and a logic forest simplification. The implementation of these two techniques in the reward function is described below.

(1) Simplification of the Logic Tree:

The simplification of logic tree is basically implemented for the corresponding flow valve in the Boolean logic. It mainly uses a Quine-McCluskey method to simplify an internal logic of the flow valve. In other words, it merges and cancels the control valves used in the internal logic. For example, control patterns, such as x̅₁x̅₂x̅₃x̅₄ and x̅₁x̅₂x̅₃x̅₄, are allocated to the multi-channel combinations represented by the second and fourth rows of the multi-path matrix in (10), respectively. A simplified logical tree for flow valves f₂ is shown in FIG. 6, where control valves x̅₁, x₂ and x₄ are merged accordingly, and x₃ and x̅₃ are cancelled out because they are complementary. It can be seen from FIG. 6 that the number of control valves used in the internal logic of f₂ has been reduced from 8 to 3. Therefore, in order to achieve the maximum simplification of the internal logic, we design the reward function combined with this simplification method.

For the design of the reward function, the following variables are considered. Firstly, we consider the situation in which the control patterns have been allocated to the corresponding multi-channel combination in the current state, the number of control valves that can be simplified by allocating this pattern is expressed by sᵥ^{c}. Secondly, on the basis of the above situation, we randomly assign another feasible pattern for a next combination, and the number of control valves that can be simplified in this way is expressed by sᵥⁿ. In addition, we consider the case where the next multi-channel combination successively allocates the remaining control patterns in the current state. In this case, we take the maximum number of control valves required by the control logic, expressed by Vₘ. Based on the above three variables, the reward function from state sᵢ to sᵢ₊ₕ₋₃ is expressed as rₜ=sᵥ^{c}+λ×sᵥⁿ−β×Vₘ, wherein λ and β are two weight factors, whose values are set to 0.16 and 0.84 respectively. These two factors mainly indicate an extent to which two situations involving the next combination in the current state influence pattern selection.

(2) Simplification of Logical Forest:

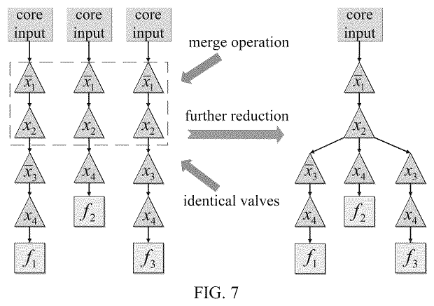

Simplification of the logic forest is achieved by merging simplified logic trees between flow valves to further optimize the control logic in a global manner. The same example of the multi-path matrix in (10) above is used to illustrate this optimization approach, which is primarily achieved through a sequentially merged logical tree of f₁-f₃ to share more valve resources, wherein the simplification procedure is shown in FIG. 7. In general, this simplification method mainly applies to a situation where all multi-channel combinations have been allocated corresponding control patterns. In this section, we use this simplification technique to design the reward functions for termination state sᵢ₊ₕ₋₁ and state sᵢ₊ₕ₋₂. Because for these two states, it is easier for the agent to consider the case where all combinations are allocated. In this way, the reward functions can be effectively designed to guide the agents to seek more efficient pattern allocation schemes.

For states sᵢ₊ₕ₋₂, when the current multi-channel combination has already been allocated control patterns, we consider the case where the last combination selects the remaining available patterns, where the minimum number of control valves required by the control logic is represented by Vᵤ. On the other hand, for the termination state sᵢ₊ₕ₋₁, the sum of control valve and path length is considered and expressed by sₚ^{v}. For these last two states, the case involving variable sᵥ^{c} mentioned above is also considered. Therefore, for the termination state S^{i+h-1}, the reward function is represented as rₜ=sᵥ^{c}−sₚ^{v}, and for the state sᵢ₊ₕ₋₂, the reward function is represented as rₜ=sᵥ^{c}−Vᵤ.

To sum up, the overall reward function can be expressed as follows:

$${r}_{t} = \{ \begin{matrix}{S}_{v}^{c} + λ \cdot {S}_{v}^{n} - β \cdot {V}_{m} , & if {s}_{t} ∈ [ {s}_{i} , {s}_{i + h - 3} ] , \\ {S}_{v}^{c} - {V}_{u} , & if {s}_{t} is {s}_{i + h - 2} , \\ {S}_{v}^{c} - {S}_{p}^{v} , & otherwise .\end{matrix} \qquad ( 11 )$$

After designing the above three elements, the agent can construct the control logic in the way of reinforcement learning. In general, the problem concerning the reinforcement learning is mainly solved through a Q-learning approach, which focuses on estimating a value function of each state-action pair, i.e., Q(s,a), thus selecting an action with a maximum Q-value in the current state. In addition, the value of Q(s,a) is calculated based on the reward received for performing the action a in the state S. In fact, the reinforcement learning is a mapping relationship between a learning state-action pair and the reward.

For the state sₜ ∈S and action aₜ ∈A at time t, the Q value of the state-action pair, that is, Q(sₜ,aₜ), is predicted by iterative updating of the formula shown below.

$$Q ( {s}_{t} , {a}_{t} ) = {Q}^{′} ( {s}_{t} , {a}_{t} ) + α [ ( {r}_{t} + γ {max}_{a ∈ A} Q ( {s}_{t + 1} , a ) ) - {Q}^{′} ( {s}_{t} , {a}_{t} ) ] \qquad ( 12 )$$

where α∈ (0,1] represents a learning rate, and γ∈ [0,1] represents a discount factor. The discount factor reflects relative importance between the current reward and future reward, and the learning rate reflects a learning speed of the agent. Q′(sₜ,aₜ) represents an original Q value of this state-action pair. rₜ is the current reward received from the environment after performing the action aₜ, sₜ₊₁ represents the state at the next moment. Essentially, Q-learning estimates a value of Q(sₜ,aₜ) by approximating a long-term cumulative reward, wherein the long-term cumulative reward is the sum of the current reward rₜ and the maximum Q value

$$( i . e . , γ {max}_{a ∈ A} Q ( {s}_{t + 1} , a ) )$$

of all the actions that can be discounted in the next state sₜ₊₁.

As the evaluation value of a largest operator in the Q-learning, namely, max Q_{α∈A}(sₜ₊₁, α), is overestimated, the sub-optimal action exceeds the optimal action in Q value, resulting in the failure to find the optimal action. Based on the existing work, the DDQN can effectively solve the above problems. Therefore, in our proposed approach, we use this model to design the control logic. The structure of the DDQN consists of two DNNs, called a policy network and a target network, wherein the policy network is the state selection action and the target network evaluates the quality of the action taken. The two work alternately.

In the training process of the DDQN, in order to evaluate the quality of the action taken in the current state sₜ, the policy network firstly finds the action aₘₐₓ, which maximizes the Q value in the next state sₜ₊₁, as follows:

$${a}_{max} = {argmax}_{a ∈ A} Q ( {s}_{t + 1} , a , {θ}_{t} ) \qquad ( 13 )$$

wherein θₜ represents parameters of the policy network.

The next state sₜ₊₁ is then transmitted to the target network to calculate a Q value of the action aₘₐₓ (i.e., Q(sₜ₊₁,aₘₐₓ,θₜ³¹)). Finally, the Q value is used to calculate a target value Yₜ, which is used to evaluate the quality of the action taken in the current state sₜ, as follows:

Yₜ=rₜ+γQ(sₜ₊₁,aₘₐₓ,θₜ⁻) (14)
wherein θₜ⁻ represents parameters of the target network. In the process of calculating the Q value for the state-action pair, the policy network usually takes state sₜ as an input, while the target network takes state sₜ₊₁ as an input.

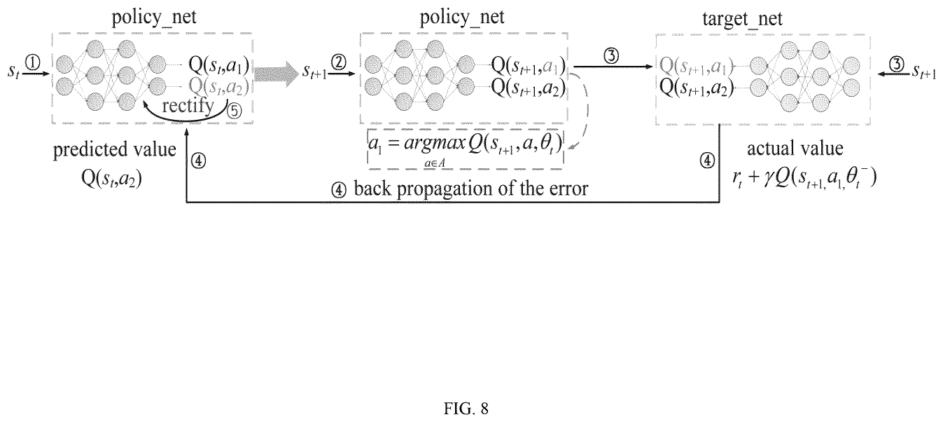

Through the above policy network, Q values of all possible actions in the state of sₜ can be obtained, and then appropriate action can be selected for the state through the action selection policy. Taking action a₂ selected by the state sₜ as an example, as shown in FIG. 8, to reflect a parameter update process in the DDQN. Firstly, the policy network can determine the value of Q(sₜ,a₂). Secondly, we use the policy network to find the action a₁ with the maximum Q value in the next state sₜ₊₁. Then, the next state sₜ₊₁ is taken as an input to the target network to obtain the Q value of the action a₁, i.e., Q(sₜ₊₁,a₁) Furthermore, according to (14), Q(sₜ₊₁,a₁) is used to obtain the target value Yₜ. Then, Q(sₜ,a₂) is used as a predicted value of the policy network, and Yₜ is used as an actual value of the policy network. Therefore, the value function in the policy network is corrected by using the error backpropagation of the two values. We can adjust the structures of these two DNNs according to actual training results.

In the present invention, both neural networks in the DDQN consist of two fully connected layers and are initialized with random weights and bias.

Firstly, the parameters related to the policy network, target network, and experiential replay buffer must be initialized separately. Specifically, an experiential replay buffer is a buffer of a loop that records information allocated by previous control patterns in each round. These pieces of information are often referred to as a transition. The transition consists of five elements, i.e., (sₜ,aₜ,rₜ,sₜ₊₁,done). In addition to the first four elements described above, the fifth element done represents whether a termination state has been reached, and is a variable with value of 0 or 1. Once the value of done is 1, it means that all multi-channel combinations have been allocated the corresponding control patterns. Otherwise, there are still combinations to which control patterns need to be allocated in the multi-channel matrix. By setting a storage capacity for the experiential replay buffer, if the number of transitions stored exceeds the maximum capacity of the buffer, the oldest transition will be replaced by the newest transition.

Training sessions (episodes) are then initialized as constants E, and the agent is ready to interact with the environment. Before the beginning of the interaction process, we need to reset the parameters in the training environment. In addition, before each round of interaction begins, it needs to check whether the current round has reached the termination state. In a round, if the current state has not reached the termination state, feasible control patterns are selected for the multi-channel combination corresponding to the current state.

The calculation of Q value in the policy network involves action selection. The ε-greedy policy is mainly used to select the control pattern from the action space, in which ε is a randomly generated number and is distributed in an interval [0.1, 0.9]. Specifically, the control pattern with the maximum Q value is selected with a probability of ε. Otherwise, the control pattern is randomly selected from an action space A. This policy enables the agent to choose a control pattern with a trade-off between development and exploration. In the course of training, the value of ε is increased with the influence of an increment coefficient ε̅. Next, when the agent completes the allocation of the control patterns in the current state sₜ, it will obtain the current reward rₜ of the round according to the designed reward function. At the same time, the next state sₜ₊₁ and the termination symbol done are obtained.

After that, the transition made up of these five elements is stored in sequence in the experiential replay buffer. After a certain number of iterations, the agent is ready to learn from previous experiences. During the learning process, small batch transitions are needed to be randomly selected from the experiential replay buffer as learning samples, which enables the network to be updated more efficiently. The loss function in (15) is used to update the parameters of the policy network by adopting gradient descent back propagation.

L(θ)=E[(rₜ+γQ(sₜ₊₁,a°;θₜ⁻)−Q(sₜ,aₜ,θₜ))²] (15)

After several cycles of learning, the old parameters of the target network are periodically replaced by the new parameters of the policy network. It should be noted that the current state transitions to the next state sₜ₊₁ at the end of each round of interaction. Finally, the agent uses the PatternActor to record a best solution found so far. The whole learning process ends with the number of training sessions set earlier.

The above are preferred embodiments of the present invention, and any change made in accordance with the technical solution of the present invention shall fall within the protection scope of the present invention if its function and role do not exceed the scope of the technical solution of the present invention.

What is claimed is:

1. A deep reinforcement learning (DRL)-based control logic design method for continuous microfluidic biochips, wherein the DRL-based control logic design method comprises the following steps:
S1. calculating a multi-channel switching scheme: constructing an integer linear programming model to minimize a number of time slices required by a control logic, wherein the multi-channel switching scheme is obtained;
S2. allocating control patterns: after obtaining the multi-channel switching scheme, allocating a corresponding control pattern for each multi-channel combination in the multi-channel switching scheme; and
S3. performing a PatternActor optimization: constructing a control logic synthesis method based on DRL, and optimizing a generated control pattern allocation scheme to minimize a number of control valves used.

2. The DRL-based control logic design method according to claim 1, wherein step S1 is as follows:
firstly, given state transition sequences of all flow valves/control channels in a biochemical application, a state matrix \tilde{P} is constructed to contain a whole state transition process of the biochemical application, wherein each row in the state matrix \tilde{P} represents a state of each control channel at every moment; the corresponding control channel is connected to a core input, and a pressure value of the core input is set and transmitted to the corresponding flow valve;
secondly, a switching matrix \tilde{Y} is configured to represent an operation needed to be performed in the control logic, wherein in the switching matrix \tilde{Y}, element 1 represents that a control channel has been connected to the core input at this time and a status value in the current control channel has been updated to the pressure value of the core input; element 0 represents that the control channel is not connected to the core input and the status value in the current control channel is not updated; element X represents that the state value is unchanged at two adjacent moments; each row of the switching matrix \tilde{Y} is called a switching pattern; since there may be more than one element in a row of the switching matrix \tilde{Y}, the states of the control channels corresponding to the switching pattern may not be updated at the same time; at this time, the switching pattern is needed to be divided into a plurality of time slices, and a plurality of corresponding multi-channel combinations are configured to complete the switching pattern; and, for the switching matrix \tilde{Y}, a number of rows is a total number of switching patterns required to complete all state transitions, and a number of columns is a total number of control channels in the control logic;
for N control channels, a multiplexed matrix \tilde{X} with N columns is configured to represent 2^{N}−1 multi-channel combinations, wherein at least one combination is needed to be selected from all rows in the multiplexed matrix \tilde{X} to realize the switching pattern represented by each row in the switching matrix \tilde{Y}; the multi-channel combination of switching pattern for each row in the switching matrix \tilde{Y} is determined by positions and number of elements 1 in the switching pattern, that is, a number of optional multi-channel combinations to realize the corresponding switching pattern is 2ⁿ−1, wherein n represents the number of elements 1 in the switching pattern;
wherein for the switching pattern of each row in the switching matrix \tilde{Y}, a joint vector group \vec{M} is constructed to contain alternative multi-channel combinations, wherein the alternative multi-channel combinations are allowed for forming each switching pattern; a number of vector groups in the joint vector group \vec{M} is the same as a number of rows X′ in the switching matrix \tilde{Y}, and each vector group contains 2ⁿ−1 sub-vectors with dimension N, and the sub-vectors are alternative multi-channel combinations to realize the corresponding switching pattern; when an element m_{i,j,k} in the joint vector group \vec{M} is 1, it means that the corresponding control channel of the element m_{i,J,k} is related to a realization of an i-th switching pattern;
since an ultimate goal of the multi-channel switching scheme is to realize the switching matrix \tilde{Y} by selecting the multi-channel combination represented by the sub-vectors of each vector group in the joint vector group \vec{M}, a method array \hat{T} is constructed to represent that the positions in \vec{M} of the corresponding multi-channel combinations configured for the switching pattern of each row in the switching matrix \tilde{Y}, wherein the method array \hat{T} contains X′ sub-arrays, and the number of elements in the sub-array is determined by the number of elements 1 in the switching pattern corresponding to the sub-array, wherein the number of elements in the sub-array is 2ⁿ−1; and, an i-th sub-array in the method array \hat{T} represents a combination of an i-th vector group in \vec{M} is selected to realize the switching pattern of an i-th row of the switching matrix;
for an element y_{i,k} in the switching matrix \tilde{Y}, when a value of the element y_{i,k} is 1, it indicates that an i-th switching pattern involves a k-th control channel to realize a state switching, wherein it is necessary to select a sub-vector that is also 1 in a k-th column from the i-th vector group in the joint vector group \vec{M} to realize the switching pattern, and this constraint is expressed as follows:
$${\sum }_{j = 0}^{j = H ( j ) - 1} {t}_{i , j} {m}_{i , j , k} \{ \begin{matrix}\geq 1 , {y}_{i , k} = 1 \\ = 0 , {y}_{i , k} = 0\end{matrix} \qquad ( 1 )$$
∀i=0, . . . ,X−1,k=0, . . . ,N−1
wherein H(j) represents a number of sub-vectors in a j-th vector group in the joint vector group \vec{M}; m_{i,j,k} and y_{i,k} are given constants, and t_{i,j} is a binary variable with value of 0 or 1;
a maximum number of control patterns allowed to be configured in the control logic is determined by a number of external pressure sources and is expressed as a constant Q_{cw} and has a value of 2┌log₂N┐, wherein the value of 2┌₂N┐ is far less than 2^{N}−1; in addition, for sub-vectors selected from the joint vector group \vec{M}, a binary row vector \vec{G} with a value of 0 or 1 is constructed to record the non-repeating sub-vectors selected at last, namely, the multi-channel combination; and a total number of non-repeating sub-vectors finally selected cannot be greater than Q_{cw}, wherein the constraint is as follows:
$${\sum }_{i = 0}^{i = c - 1} {G}_{i} \leq {Q}_{cw} \qquad ( 2 )$$
wherein C represents the total number of non-repeating sub-vectors contained in the joint vector group \vec{M};
if a j-th element of the i-th sub-array in the method array \hat{T} is not 1, the multi-channel combination represented by a j-th sub-vector of the i-th vector group in the joint vector group \vec{M} is not selected; however, other sub-vectors with a same value of a sub-vector element may exist in other vector groups in the joint vector group \vec{M}, wherein the multi-channel combination with a same value of the element may still be selected; only when a multi-channel combination is not selected in a whole process, a column element corresponding to the multi-channel combination in \vec{G} is set to be 0, and a constraint thereof is as follows:
t_{i,j}≤G_{[m}_{_{i,j}}_{]} (3)
∀i=0, . . . ,X−1,j=0, . . . ,H(j)
wherein [m_{i,j}] represents a position in \vec{G} of multi-channel combination with the same value as the j-th sub-vector element of the i-th vector group in the joint vector group \vec{M};
each sub-array in the method array \hat{T} indicates which multi-channel combinations represented by sub-vectors are selected from the vector group of the joint vector group \vec{M} to realize the corresponding switching pattern in the switching matrix \tilde{Y}; the number of elements 1 in each sub-array in the method array \hat{T} represents the number of time slices needed to realize the corresponding switching pattern in the switching matrix \tilde{Y} of the sub-array; wherein in order to minimize the total number of time slices of all switching patterns in the switching matrix \tilde{Y}, an optimization problem solved is as follows:
$$minimize {\sum }_{i = 0}^{X - I} {\sum }_{j = 0}^{H ( j ) - 1} {t}_{i , j} \\ s . t . ( 1 ) , ( 2 ) , ( 3 )$$
by solving the optimization problem as shown above, the multi-channel combination required to realize the whole multi-channel switching scheme is obtained according to the value of \vec{G}; similarly, the multi-channel combinations configured for the switching pattern of each row in the switching matrix \tilde{Y} are determined by the value of t_{i,j}; wherein when the value of t_{i,j} is 1, the multi-channel combination are the values of the sub-vectors represented by M_{i,j}.

3. The DRL-based control logic design method according to claim 1, wherein step S2 is as follows: the multi-channel switching scheme is represented by a multi-path matrix; corresponding control patterns are allocated to the multi-channel combination in each row of the multi-path matrix; and these control patterns are written on a right side of the multi-path matrix.

4. The DRL-based control logic design method according to claim 1, wherein in step S3, the control logic synthesis method based on DRL adopts a double deep Q network and two kinds of Boolean logic simplification techniques as the control logic.

5. The DRL-based control logic design method according to claim 1, wherein in step S3, in the PatternActor optimization process, a double deep Q-network (DDQN) model is constructed as a reinforcement learning agent, and deep neural networks (DNNs) are configured to record data; a number of control ports available in the control logic is initialized as 2×┌log₂N┐, and the control ports form 2 ┌log₂N┐ kinds of control patterns accordingly; and the PatternActor optimization process is as follows:
S31. Designing a State of PatternActor
designing an agent state s: the multi-channel combination of time t is connected in series with a coded sequence of selected actions in all the time to design the state; the multi-channel switching scheme is represented by a multi-path matrix; a length of an encoding sequence is equal to a number of rows of the multi-path matrix, wherein each multi-channel combination corresponds to a bit of action code; and all states form a state space S;
S32. Designing an Action of PatternActor
designing an agent action a: a channel combination needs to be allocated corresponding control patterns; action is the control pattern, wherein the control pattern has not been selected, and each control pattern is only allowed to be selected once; all the control patterns generated by the control port constitute an action space A; in addition, the control patterns in A are coded in an ascending order; when the agent takes an action in a predetermined state, the action code indicates which control pattern has been allocated;
S33. Designing a Reward Function of PatternActor
designing an agent reward function r: through a design of a state of reward function, the agent obtains an effective signal and learns in a correct way; for a multi-path matrix, assuming that the number of rows in the multi-path matrix is h, an initial state is represented as sᵢ, and a termination state is represented as sᵢ₊ₕ₋₁; and an overall reward function is expressed as follows:
$${r}_{t} = \{ \begin{matrix}{S}_{v}^{c} + λ \cdot {S}_{v}^{n} - β \cdot {V}_{m} , & if {s}_{t} ∈ [ {s}_{i} , {s}_{i + h - 3} ] , \\ {S}_{v}^{c} - {V}_{u} , & if {s}_{t} is {s}_{i + h - 2} , \\ {S}_{v}^{c} - {S}_{p}^{v} , & otherwise .\end{matrix}$$
wherein, sᵥ^{c} represents a number of control valves allowed for being simplified by allocating feasible control patterns for the corresponding multi-channel combinations under a current state; sᵥⁿ represents a number of control valves allowed for being simplified under the current state by allocating feasible control patterns for a next multi-channel combination; Vₘ represents a maximum number of control valves required by the control logic, wherein λ and β are two weighting factors; sᵢ₊ₕ₋₂ and sᵢ₊ₕ₋₃ are respectively a previous state and a state before the previous state of the termination state sᵢ₊ₕ₋₁; sₚ^{v} represents a sum of a length of the control valve and a length of a path in the termination state sᵢ₊ₕ₋₁; for the previous state sᵢ₊ₕ₋₂, when the current multi-channel combination has been allocated the control patterns, considering a case that the last multi-channel combination selects remaining available patterns, a minimum number of control valves required by the control logic is represented by Vᵤ;
S34. using the DDQN model to design the control logic, a structure of the DDQN model is consisted of two DNNs, namely, a policy network and a target network, wherein the policy network is a state selection action, and the target network evaluates a quality of the action taken; and the policy network and the target network work alternatively;
in a training process of DDQN, in order to evaluate the quality of the action taken in the current state sₜ, the policy network firstly finds an action aₘₐₓ, wherein the action aₘₐₓ maximizes a Q value in a next state sₜ₊₁, as shown below:
$${a}_{max} = {argmax}_{a ∈ A} Q ( {s}_{t + 1} , a , {θ}_{t} )$$
wherein θₜ represents a parameter of the policy network;
the next state sₜ₊₁ is transmitted to the target network to calculate a Q value of the action aₘₐₓ, i.e., Q(sₜ₊₁, aₘₐₓ, θₜ⁻); and the Q value is configured to calculate a target value Yₜ, wherein the target value Yₜ is configured to evaluate the quality of the action taken in the current state sₜ, as follows:
Yₜ=rₜ+γQ(sₜ₊₁,aₘₐₓ,θₜ⁻)
wherein θₜ⁻ represents a parameter of the target network; in a process of calculating Q value for a state-action pair, the policy network takes a state sₜ as an input, while the target network takes a state sₜ₊₁ as input;
through the policy network, Q values of all possible actions in the state sₜ are obtained, and actions are selected for the state sₜ by an action selection policy; firstly, the policy network determines a value of Q(sₜ,a₂); secondly, an action a₁ with a maximum Q value in the next state sₜ₊₁ is found through the policy network; the next state sₜ₊₁ is taken as the input of the target network to obtain a Q value of the action a₁, that is, Q(sₜ₊₁,a₁) and obtain a target value Yₜ according to Yₜ=rₜ+γQ(sₜ₊₁,aₘₐₓ,θₜ⁻); Q(sₜ,a₂) is configured as a predicted value of the policy network, and Yₜ is configured as an actual value of the policy network; a value function in the policy network is corrected by using an error backwards propagation between the predicted value of the policy network and the actual value of the policy network, and the policy network and the target network of the DDQN model are adjusted.

6. The DRL-based control logic design method according to claim 5, wherein in step S33, two Boolean logic simplification methods are configured to design the reward function: a logic tree simplification and a logic forest simplification.

7. The DRL-based control logic design method according to claim 5, wherein in step S34, both the policy network and the target network in the DDQN model are consisted of two fully connected layers, wherein the two fully connected layers are initialized with a random weight and a bias;
firstly, parameters related to the policy network, the target network and an experiential replay buffer are initialized respectively; the experiential replay buffer records information transitions allocated by a previous control pattern in each round and is consisted of five elements, that is, (sₜ,aₜ,rₜ,sₜ₊₁, done), the fifth element done represents whether the termination state has been reached, wherein the fifth element done is a variable with value of 0 or 1;
then, a training session episode is initialized as a constant E, and the agent is ready to interact with the environment;
the transition made up of the five elements are stored in the experiential replay buffer; after a predetermined number of iterations, the agent is ready to learn from previous experiences; in a learning process, the transitions are randomly selected as learning samples from the experiential replay buffer to update the network; and the following loss function is configured to update the parameters of the policy network by using a gradient descent back propagation:
L(θ)=E[(rₜ+γQ(sₜ₊₁,a°;θₜ⁻)−Q(sₜ,aₜ,θₜ))²]
after several cycles of learning, old parameters of the target network are periodically replaced by new parameters of the policy network; and
finally, the agent uses the PatternActor to record a best solution found so far; and the whole learning process ends with a set number of training sessions.

8. The DRL-based control logic design method according to claim 5, wherein in step S34, the action selection policy adopts a ε-greedy policy, wherein ε is a randomly generated number and is distributed in an interval [0.1, 0.9].
